(19) United States
(12) Patent Application Publication
(10) Pub. No.: US 2009/0260182 A1
(43) Pub. Date: Oct. 22, 2009

(54) Anti-movement device for closure member

(76) Inventor: Nigel John Hall, Oxfordshire (GB)

Correspondence Address: MACMILLAN SOBANSKI & TODD, LLC, ONE MARITIME PLAZA FIFTH FLOOR, 720 WATER STREET, TOLEDO, OH, 43604-1619, US

(21) Appl. No.: 11/991,304

(22) PCT Filed: Aug. 23, 2006
(86) PCT No.: PCT/GB2006/003158

§ 371 Date: Feb. 29, 2008

Related U.S. Application Data
(60) Provisional application No. 60/712,796, filed on Aug. 30, 2005.

(30) Foreign Application Priority Data
Aug. 30, 2005 (GB) 0517616.9

(51) Int. Cl. E05C 17/02; E05F 5/02

(52) U.S. Cl. 16/82

(57) ABSTRACT

A device (15) for inhibiting the movement of a closure member, such as a door (1), window or hatch, which is hingeably mounted by means of one or more hinges (3) to a frame portion defining an edge of an opening between two areas of space The device comprises: i) a compression resistive portion; and ii) a holding means (14) for holding the compression resistive portion in a radial gap formed between the closure member (2) and the frame portion (2) as the closure member (2) is moved from a closed position in an opening direction, and wherein, when positioned in the radial gap in use, the compression resistive portion (15) serves to resist movement of the closure member (2) in the closing direction.

The present invention relates to a device for preventing, or at least inhibiting, the movement of a closure member. In particular, the present invention relates to a device for preventing or inhibiting the movement of a closure member which is operable to close, or at least partially close, an opening between two areas of space.

An opening exists between two areas of space, such as between two rooms of a building, in order to allow access to one room from the other room. Openings also exist in a multitude of other situations, for example, between two fields, between an inside space (such as a building or vehicle) and an outside space, or in an appliance or apparatus to allow access to, for example, an area of space provided in the appliance or apparatus.

Typically, an opening is defined by a frame, such as a door frame, which may be formed in a wall between two areas of space. Alternatively, an opening may be defined by a pair of posts which, together with the ground, define an opening between two fields. Thus, it should be appreciated that an opening need not be defined by four frame portions, but could be defined by any number of frame portions.

Any opening is commonly provided with a closure member, such as a door, gate, window or hatch, which is operable to close, or at least partially close, the opening between the two areas of space. For example, a door is commonly mounted, in a pivotal fashion, to one edge of a doorframe which defines an opening between two rooms. Typically, any closure member such as a door or gate, is hingeably mounted to one frame portion and is operable to move relative to said frame portion between an open position, in which the opening between the two areas is revealed to a maximum extent, and a closed position, in which the opening between two areas of space is closed to a minimum extent (which may only be partially closed). Often, one side of a closure member is provided with a latch which may engage or cooperate in some way with a second frame portion when in a closed position in order to secure the closure member in the closed position.

A closure member is generally, but not necessarily, substantially planar in form and will usually comprise a front face and a rear face. An edge is formed between the two planer faces, one portion of which may comprise a so-called “hinge edge”, and another portion of which may comprise a so-called “latch edge”. Thus, the hinge edge is the edge of the closure member which is at, or nearest to, the hinge joint. The hinge side of the door is the part of the door in the vicinity of the hinge edge and it should be noted that a hinge joint may not be attached along the hinge edge of the door, but may instead be attached to one of the door faces at the hinge side of the door.

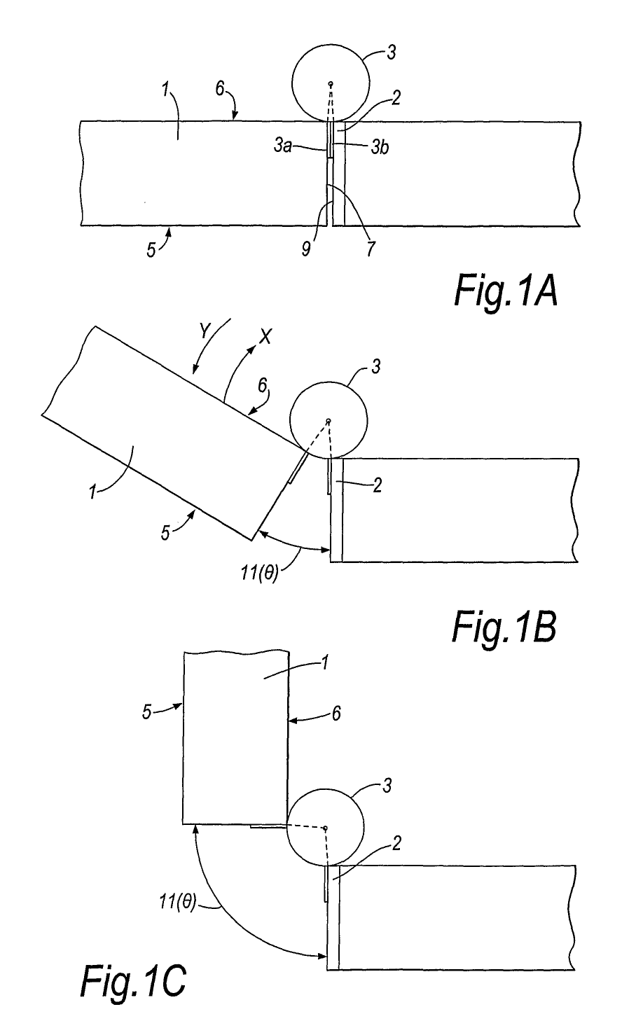

Hinges are a well known mechanism for connecting two members together whilst allowing for relative pivotal movement between them. The term hinge should be interpreted generally as meaning a means or joint for holding two parts together so that one can swing relative to the other. Various types of hinge joint are known and include, inter alia: butt and loose-pin hinges, projection hinges, parliament hinges, raised barrel hinges, electrical hinges and swaged hinges. The hinge most commonly employed in conjunction with a domestic door scenario is a butt hinge and, as illustrated in FIG. 1 (not to scale), generally comprises two plates 3a and 3b, each joined by a pin 3 and for attachment to one of two (abutting) surfaces. In use, one hinge plate is connected to each of the two faces which are to be hinged together. Typically, one hinge plate is connected to frame portion 9 of a door frame and the other to the hinge side 7 of the door 1. It should be noted that the gap between surfaces 7 and 9 shown in FIG. 1A is, in reality, minimal.

When some force is applied to a closure member, for example a door, it is caused to swing about the frame portion of the frame to which the closure member is mounted in either a closing direction (direction Y in FIG. 1B) or an opening direction (direction X in FIG. 1B) depending on the direction of the force applied. This pivotal motion is facilitated by one or more hinges and can often be achieved with relatively little force with the consequence that if it is desired to maintain a closure member in a particular position, some mechanism should advantageously be employed to prevent, or resist, movement of the closure member.

Thus, a closure member may swing freely in an opening or a closing direction about one or more hinges thereby allowing the size of the doorway, or other opening, to be varied. Although it is relatively easy to arrange for a closure member to be secured in a closed position, for example by means of a latch or frictional forces arising as one side of the closure member abuts or makes frictional contact with a frame portion, there are many instances where there is a need to inhibit the movement of a closure member.

One of the greatest needs to inhibit the movement of a closure member arises for reasons of safety. Many types of closure system represent a potential hazard to humans or animals in the vicinity of the closure system due to forces which arise during the movement of a closure member. For example, in the case of a door, considerable forces may be applied intentionally or unintentionally to the door thereby causing it to swing in a pivotal fashion about the door frame. Clearly, there is a risk that something or someone may obstruct the motion of the door and therefore that the rotational force may be dissipated in such a manner as to cause damage or harm. Despite a number of devices intended to inhibit or prevent the inadvertent motion of a closure member, there are unfortunately countless incidents each year of people or animals, and in particular children, having their hands or other part of their anatomy trapped between a closure member such as a door or window and the associated frame. Anything obstructing the motion of a closure member in the proximity of the frame will nearly always experience a force which is greater than human or animal tissue and bone can withstand and may result in serious injury, wounding, pain, distress and suffering to any person or animal that has any part of its anatomy within the areas of the system where the doorframe and the door meet when closing. The fingers are particularly vulnerable to this sort of injury.

Parents of small children are particularly aware and frightened by the hazards associated with doorways. Whilst most adults are aware of the need to keep, say, their fingers clear of these areas of the door and doorframe, this is not the case with small children, who are particularly vulnerable to this sort of event. Each year there are a substantial number of these incidents ranging from slight to very serious injury and causing enormous distress and alarm to both the child involved and to their parents. Unfortunately there are instances where such incidents require emergency medical care, including surgery.

It may also be advantageous to prevent or hinder the movement of a door when in a non-closed position simply for reasons of convenience. For example, there is often a need to secure the door in an open position in circumstances where it may be difficult or impossible to operate the door, for example, to allow a wheelchair to pass through the opening or whilst carrying bulky items through the opening.

There currently exist a number of devices designed to impede or stop the movement of a closure member, for example: a so-called “wedge”, a catch, a bolt, a foam grip or an adjustable rubber block.

The most commonly employed device is the wedge which provides a well-known solution to the problem of impeding the movement of a closure member, usually a door, and is typically made from wood. In use, it is intended to be located in the gap between the bottom of a door and the floor such that the thinner end of the wedge extends under the door. The extent to which the wedge may extend under the door is determined by the size of the gap between the floor and the bottom of the door. Thus, the position of the door can be substantially maintained as a result of friction provided by the wedge between the floor and the bottom of the door.

However, there are a number of problems associated with the well-known wedge devices. For example, the wedge requires a suitable flooring surface in order to provide sufficient friction to substantially maintain its position. Flooring materials and conditions obviously vary considerably in any number of commercial or domestic situations and many fail to provide the friction required to stop the wedge from moving.

In use, a wedge should be located firmly in the gap between the floor and the door. In order for the wedge, and thus the door, to become secure and substantially immovable, it is necessary to exert a force along the length of the wedge which is sufficient to drive it firmly into the gap. However, techniques employed to locate a wedge are often ineffective as the amount of pressure required to ensure minimum movement between the door, the wedge and the floor, is difficult to apply. Should an insufficient force be applied along the length of the wedge, the frictional contact between the wedge, the door and the floor can be easily overcome, resulting in the wedge loosing its original position in the gap and thereby allowing the door to move about its hinges.

For the wedge to be secure and immovable it is preferable for the surfaces of the floor and/or the door to exhibit a degree of compressibility such that, once a wedge has been driven into a gap, the natural tendency of the surface(s) to decompress will create a gripping force to hold the wedge in place. However, repeated use of a wedge in a particular situation can lead to such surfaces being damaged and/or loosing their compressibility so that the required gripping force is lost.

Should neither of the surfaces be able to provide some degree of compression (for example a hard wood door and ceramic floor tile), or if one of the surfaces exhibits too much compressibility, (for example, a deep pile carpet), then the ability of the wedge to be located in a secure and immovable fashion is greatly inhibited.

Situations where a wedge is appropriate are limited. Many openings do not comprise a door/floor scenario applicable. Gates, shed doors, kitchen cupboard doors etc are just some examples where a wedge could not be conveniently used.

It can therefore be appreciated that once the wedge has lost even a small amount of its potential impedance functionality due to poor usage, interference with the position of the wedge or situational factors which render the wedge unsuitable, it rapidly loses its functionality and becomes ineffective. This has serious implications particularly when used as a safety device to prevent injury between a door and a door-frame.

Another well-known mechanism which is used to hold a door substantially immovable in an open position is a door catch. This is a two part device, typically made of plastic, and generally comprises a ‘catch’ portion, which is permanently fitted to the wall against which a door opens (i.e. behind the door), and a second portion, generally in the form of a protrusion or hook, which is fitted to the back of the door. The catch portion receives and retains or holds the second portion to thereby prevent or resist movement of the door. The catch is usually provided with some form of biasing mechanism, provided by springs or the resiliency inherent to the material of the catch itself, such that a threshold force must be applied to pull the protrusion/hook from the grip of the catch. By exerting a pulling force on the door the catch is released allowing the door to move freely.

The intention is that when the door is fully opened and the device has been engaged, the device will hold the door and prevent it from moving.

This device suffers from a number issues:

It is designed primarily to be fitted to internal wooden doors in a domestic situation typically by means of wood screws. The need to fix both parts of the device to the door/doorframe is not only inconvenient, it also means that the device is not particularly suitable for use in conjunction with other systems which employ closure members or frames made from non-wood materials such as metal or pvc. Furthermore, should the door be hollow in its construction, then the screws fixing either of the parts of the second piece to the door may be pulled out under moderate force. Fitting the catch to the door and doorframe obviously damages and affects the aesthetic quality of the door and frame. A further problem with the use of a two-part catch mechanism is that it is only usable when the door opens back against a suitable wall/skirting board. Therefore the device is not suitable for use in situations where the door opens into a space without a wall or similar behind it, or if there is a need to hold the door in a position between the fully open position and the closed position.

The strength of the device is dependent on the strength of the catch portion. By virtue of the need for this portion, often formed as a “jaw”, to open and close around the protrusion/hook, the need for the catch to be released must be balanced against the strength necessary to prohibit the withdrawal of the second portion from the catch. Furthermore, tools and a certain level of technical competence are required to fix the parts of the device to the door and the wall.

The use of a door bolt comprising a metal projection or the like which can be moved relative to the door so that it may protrude from it a in order to secure a door in an open position is also known. The bolt is permanently fitted to the door. This part also includes a movable piece of metal (the bolt) which can be extended beyond the boundary of the device and into either a suitable hole in the surrounding doorframe, wall or floor, or into the recess in the second piece of this device which is intended to be secured on the surrounding doorframe, wall or floor.

The intention is that when the door is fully opened, the bolt may be extended into its recess and thereby hold the door and prevent it from moving.

This device suffers from a number issues:

As with the door catch, this device only works when the door is fully pushed back and the bolt has been extended into the intended recess. This means that the device is only useful when the intention is to permanently or semi-permanently restrict the door.

By virtue of the need for the device to be fixed to the door, this device is only really useful where and when it has already been permanently fitted. Fixing the device to the door may damages it and effect the aesthetic quality of the door. Tools and a certain level of technical competence are required to fix the device to the door and therefore, this device is preferably fitted to the door at the point of manufacture.

Most doors etc open into an area of space above and around their tops. Therefore, the most suitable place for a bolt for use in the open position is at the bottom where the door is close to the floor. However, this position is in easy reach of small children who can simply disconnect the bolt thereby freeing the door for all movements.

The foam grip is a one-piece device that fits around the edge face of the latch side of a door. Generally, it is made of an expanded plastic foam material, approximately 20 mm thick in an oval shape with a ‘jaw’ cut out of one side that enables the device to fit around the latch side of the door so that one side of the “jaw” makes contact with the front face of the door and the other side of the “jaw” makes contact with the back face of the door. The inherent resiliency of the device enables it to remain in place on the door.

This device is intended to provide a stopping mechanism whereby when an attempt to close the door is made the device comes between the door and the doorframe. Thus, the device is an ‘anti-closing’ device, and is not intended to stop the movement of the door. As such, it will allow the door to move and to close almost to its final position without any restriction.

The material the device is manufactured from is weak in its twisting moment and can easily be twisted in use thereby greatly reducing its safety margin.

Over a short period of time, the material loses its tension and its ability to stay on the door. This also increases the chances of it easily moving inadvertently.

This device is designed to fit only internal wooden doors in a domestic situation. The device is not intended to be applicable for all door thicknesses.

The device only becomes useful when the door is almost closed, which means that it is not intended as a means of impede and/or stop the movement of an opening or closing access or exit system (e.g. door, gate, window) when in the open position.

A major disadvantage of this device is that it only seeks to protect obstructions along the latch side of the door. Consideration of the relative motion which arises at the hinge side of a door between the hinge edge and the frame portion, reveals that this device provides no protection along what is actually the more hazardous edge of a door. FIG. 1A shows (not to scale) a door 1 in a closed position. As the door 1 is moved in an opening direction X, the hinge edge 7 of the door pivots with respect to the hinge edge 9 of the frame portion to which it is mounted as facilitated by the one or more hinges 3, thereby creating a radial gap 11, which subtends an angle θ, as shown in FIG. 1B. It can be seen therefore that fingers, for example, can still be trapped in the radial gap along the hinge side of the door even though the anti-closing device may be attached to the latch end of the door. Furthermore, since the centre of the pivotal motion facilitated by a hinge 3 is often not co-axial with the corners 12 and 13 of the door and door-frame respectively, and as a consequence of the need for the hinges to therefore pivot about the pin, the radial gap extends from the area of space proximate to the front face 5 of the door through to the area of space proximate to the back face 6 of the door. Moreover, if fingers (for example) do obstruct the relative movement of the two corner edges 12 and 13, the forces experienced along these corner edges will be considerable and significantly greater than forces experienced by obstructions arising between two planer surfaces such as between an edge of a door and the door frame.

The Adjustable Rubber Block is another two-piece device that fits on the wall or frame around a door, and is adjusted to sit between the door and the doorframe. The main piece is made of rubber or a rubber like material. The second piece is a plastic nipple and backplate. The rubber piece has an opening in which the nipple is inserted. The nipple and backplate are fixed by wood screws to the surrounding wall or doorframe. The rubber piece is then engaged with the nipple. The elevation of the device is rectangular, and the opening for the nipple is near one end. This means that when not in use, the rubber piece is twisted or adjusted into a position out of the way of the doors movement, whilst when in use, the rubber piece is twisted or adjusted to be in the path of the door when nearly closed.

This device suffers from a number issues:

The device is again an ‘anti-closing’ device, and is not intended to stop the movement of the door. Thus, the serious hazards arising along the hinge side of the door, as discussed above, have not been addressed.

Furthermore, the rubber or rubber like material is too soft and flimsy to maintain long term contact with the backplane and nipple. This means that the item rapidly becomes loose and is then ineffective as a sturdy barrier against the door closing.

This device is designed to fit only internal wooden doors in a domestic situation. The device is not intended to be applicable For all types of doorways.

The device is designed to be attached to a wall or doorframe that is flat and without any adornment around the door (e.g. architrave). As such is cannot be fitted to the majority of doorways without the removal of some or all of the said adornment.

Thus, there is a need to provide a device which alleviates the problems associated with the prior art. In particularly, there is a need to provide a device which prevents or resists movement of a closure member, such as a door, and which may be readily used in conjunction with closure members of different types employed in a variety of scenarios.

According to a first aspect of the present invention there is provided an anti-movement device for inhibiting the movement of a closure member which is hingeably mounted, to a frame portion defining at least one edge of an opening between two areas of space, wherein the closure member is operable to move about the frame portion in a closing direction so as to reduce the size of the opening, and an opening direction so as to increase the size of the opening, wherein the anti-movement device comprises: i) a compression resistive body; ii) a holding means for holding the compression resistive portion in a radial gap formed between the closure member and the frame portion as the closure member is moved from the closed position in the opening direction; and iii) a shock absorbing means which allows for a degree of relative movement between the compression resistive body and the holding means, wherein, when positioned in the gap in use, the compression resistive body serves to resist movement of the closure member in the closing direction.

According to a second aspect of the present invention there is provided a device for inhibiting the movement of a closure member which is hingeably mounted by means of one or more hinges to a frame portion defining an edge of an opening between two areas of space, the device comprising: i) a compression resistive body; ii) a holding means for holding the compression resistive portion in a radial gap formed between the closure member and the frame portion as the closure member is moved from a closed position in an opening direction; and iii) a shock absorbing means which allows for a degree of relative movement between the compression resistive body and the holding means, and wherein, when positioned in the radial gap in use, the compression resistive body serves to resist movement of the closure member in the closing direction.

According to a third aspect of the present invention there is provided a method of inhibiting the movement of a closure member which is hingeably mounted by means of one or more hinges to a frame portion defining an edge of an opening between two areas of space, wherein the closure member is operable to move about the frame portion in a closing direction so as to reduce the size of the opening, and an opening direction so as to increase the size of the opening, wherein the method comprises: i) positioning a device having a compression resistive body in a radial gap formed between the closure member and the frame portion as the closure member is moved from the closed position in the opening direction; and ii) securing the position of the compression resistive portion within the radial gap by means of a holding means, wherein the device is provided with a shock absorbing means which allows for a degree of relative movement between the compression resistive body and the holding means.

A distinct advantage of a device embodying the present invention is that since it serves to resist movement of the closure member, it can greatly reduce the risk of injury or damage arising between any of the edges of the closure member and the associated frame of an opening.

Furthermore, preferred embodiments of the present invention may be fitted to, or used in conjunction with, the majority of entry and exit systems, including doors, gates, windows etc. Devices embodying the present invention are advantageously portable and can easily be taken to any location, for example, by emergency personnel.

Preferably, the holding means comprises an engagement member for engaging with the, or one of the hinges. Preferably, this engagement member is in the form of a hook which facilitates the simple attachment of the device to the hinge of a closure member. Indeed, preferred embodiments of the present invention which utilise an engagement member such as a hook, are advantageous in that application of the device to the hinge of a closure member does not require any tools or technical competence, does not cause damage to the closure member, frame portion or hinges in any way, and can be readily removed when not required. Furthermore, since removal of the device from the hinge generally requires an upwardly directing force, it is not likely to be inadvertently dislocated. Preferred embodiments of the present invention therefore provide a reliable anti-movement device for a closure member and which are beneficial from a safety point of view, especially given the hazardous nature of, in particular, the hinge-side of the door.

A particularly important advantage of embodiments of the present invention can be attributed to the provision of a shock absorbing means which allows for some relative movement between the compression resistive body and the holding means. Devices which are substantially rigid, and/or which employ a rigid connection between the body of the device and a holding means, have been found to break, or become damaged, when the closure member is subjected to significant force which would otherwise cause the closure member to move about the frame in a closing direction. An attempt to move the closure member in a closing direction, which may be deliberate or inadvertent, will exert a force on the compression resistive portion of the device which will tend to cause the body to move radially outward within the radial gap. Since it is envisaged that the holding means will preferably engage with a hinge which connects the closure member to a frame portion of the opening, any force which would otherwise cause the closure member to move in its closing direction will be resisted by the action of the holding means against the hinge. If the force exceeds a certain limit (determined by the physical properties of the device), the engagement member will break off from the compression resistive body. Devices with little or no shock absorbing function have also been found to cause damage to the closure member and/or the frame portion to which the closure member is attached through the action of forces exerted on the closure member. Furthermore, a door which is held open in a substantially fixed or rigid position, for example by means of a device having little or no shock absorbing function, may cause significant injury to a person who inadvertently collides with the door.

Preferably the compression resistive portion, which may be any solid, rigid, semi-solid or semi-rigid mass, may withstand whatever closing force it is subjected to including a deliberate and forceful attempt to slam the door. In one embodiment the compression resistive body is in the form of a rigid core which is covered, coated or surrounded by a material which has some degree of compressibility. This embodiment is advantageous, particularly if it envisaged that the closure member will be subjected to repeated force in a closing direction when the device is located in use, in that it will provide the device and the closure member and frame with some protection from damage. However, this embodiment may be relatively expensive to manufacture. It is also advantageous for the device to allow a slight degree of movement or “give” in the closing direction, without allowing for significant reduction in the size of the radial gap which may lead to injury or damage. The properties of compressibility associated with the device may be advantageously chosen to achieve this. Alternatively, according to embodiments of the present invention, this may be achieved by means of the shock absorbing means which allows a degree of relative movement between the compression resistive body and the holding means.

The shock absorbing means of the present invention may be provided in a number of ways. According to a particularly preferred embodiment, the holding means comprises an engagement member such as a hook which is pivotally connected to the compression resistive body of the device. In this case, the shock absorbing function is provided by the inherent flex allowed in the pivotal connection. Preferably, the relative movement facilitated by the pivotal connection is limited, since if too much relative movement is possible, the pivotal connection may become worn over time and the engagement member may break. Such limiting means may preferably be provided by means of an abutment member, provided on the engagement member, which contacts a corresponding abutment member provided on the compression resistive body.

An advantage of embodiments having a shock absorbing means comprising a pivotal connection between the compression resistive portion and the engagement member is that the components of the device may be formed of a substantially rigid material, whilst still allowing for some flex between the holding means the compression resistive portion. The flex will serve to absorb some of the shock which is imparted to the device if the closure member experiences a force which would otherwise cause the closure member to move about the frame in a closing direction. Thus, the likelihood of breaking the device in such circumstances is reduced. Furthermore, devices embodying the present invention may be advantageously formed from injection moulded plastic which offers the advantages of cost efficient mass manufacture.

Preferred embodiments will not be easily dislocated from the radial gap in which they are held by the holding means. Advantageously, the device is not dependent on the shape of the frame portion(s) or the closure member or the doorframe.

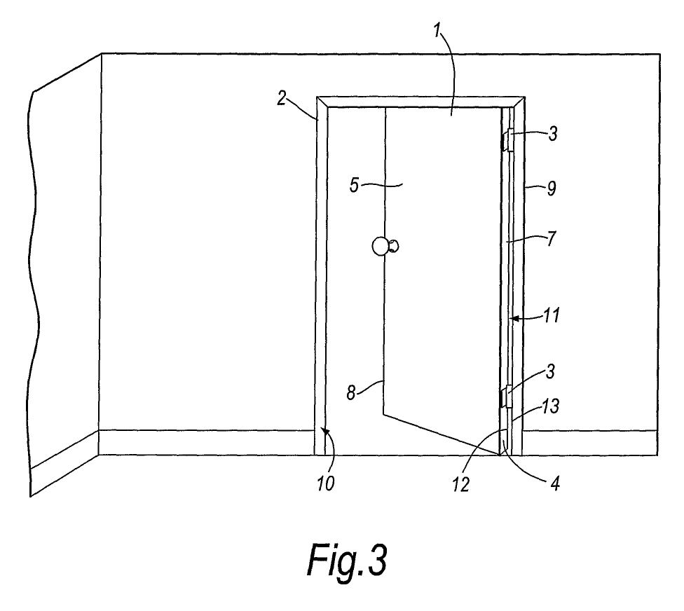

The compression resistive body may be substantially any shape which allows the device to be positioned within the radial gap and which will allow the device to fulfil its function as an anti-movement device which hinders, or prevents, movement of the closure member. It may comprise a single part or may be formed of two or more parts which are intended to be connected together for use. In a particularly preferred embodiment, however, the compression resistive body is generally “wedge” shaped, i.e. it is generally triangular in cross-section. In use the wedge shaped device is intended to be positioned within a radial gap as shown in FIG. 3. Preferably, the compression resistive body is shaped so as to resist radial movement of the hinge edge of a closure member, in a closing direction. Preferably, the compression resistive portion is shaped so as to resist any movement of the closure member in a closing direction which would reduce the angle subtended by the radial gap to less than substantially 90 degrees. The compression resistive boy may be shaped so as to resist any movement of the closure member in a closing direction which would reduce the angle subtended by the radial gap to less than substantially 60 degrees. The compression resistive body may be shaped so as to resist any movement of the closure member in a closing direction which would reduce the angle subtended by the radial gap to less than substantially 30 degrees.

An advantage of a device embodying the present invention which comprises a substantially spherical compression resistive body, is that the body need not be engineered to fit a radial gap.

As shown in the illustrated preferred embodiments, the device may comprise a mass of semi solid or solid material or materials and is substantially wedge shaped. It should be appreciated however that the device, in particular the compression resistive body, may be of any shape and size (e.g. cuboid, wedge shaped, cylindrical or spherical etc) suitable to be placed in the gap 11 between the doorframe 2 and the hinge edge of the door 1. In the preferred embodiment the device is additionally fitted with a holding means in the form of a hook 14. However, it should be appreciated that any other holding means, such as a clasp, fastener (one-part or two part) or grip, which will enable it to remain in position when placed across one of the door hinges are also suitable.

The size, shape and whether or not a type of hook device is part of the invention will vary depending on The specific requirements of the opening or closing access or exit system. For example, a version of the device to impede and/or stop the movement of an internal domestic door will be different from that designed to impede and/or stop the movement of a garden gate.

Whilst focusing on the unique benefits of the invention in terms of protecting young children from accidentally trapping their fingers between the hinge side of the door and doorframe, it is important to stress that the invention will function full and properly when placed on any of the hinges of a door and doorframe.

Thus, a parent for example, would site a device embodying the present invention on the Lop most hinge so as to deny a child access to the device. In contrast, someone such as a wheel-chair user may choose to locate the device on the bottom hinge and the device may be advantageously used to allow convenient and easy access through an opening between two rooms, for example, without the need to operate the door.

The device may be formed of pliable and/or semi-pliable material such that it absorbs the majority of impact, movement and closing forces to thereby impede and/or stop the radial movement of the door in a closing direction. The device may optionally be additionally fitted with a hook or any other device such as a clasp, fastener or grip, which will enable it to remain in position when placed across one of the door hinges. Embodiments are envisaged in which the size of the compression resistive body is variable and can be adjusted as dictated according to the angle most appropriate to avoid injury or damage to an obstruction arising within the radial gap. The device may comprises a generally rigid generally cuboid body having an integral hook or other engagement member for placing over the top of the generally round cylindrical mid section of a door hinge in order to hold the device in-place and prevent it from either falling or moving when in use. Preferably a device embodying the present invention is suitable for left-handed and right-handed hinged doors.

For a better understanding of the present invention, and to show how the same may be carried into effect, reference will now be made, by way of example, to the accompanying drawings in which:

FIG. 1 illustrates the pivotal movement of a door with respect to a door frame at the hinge side of the door;

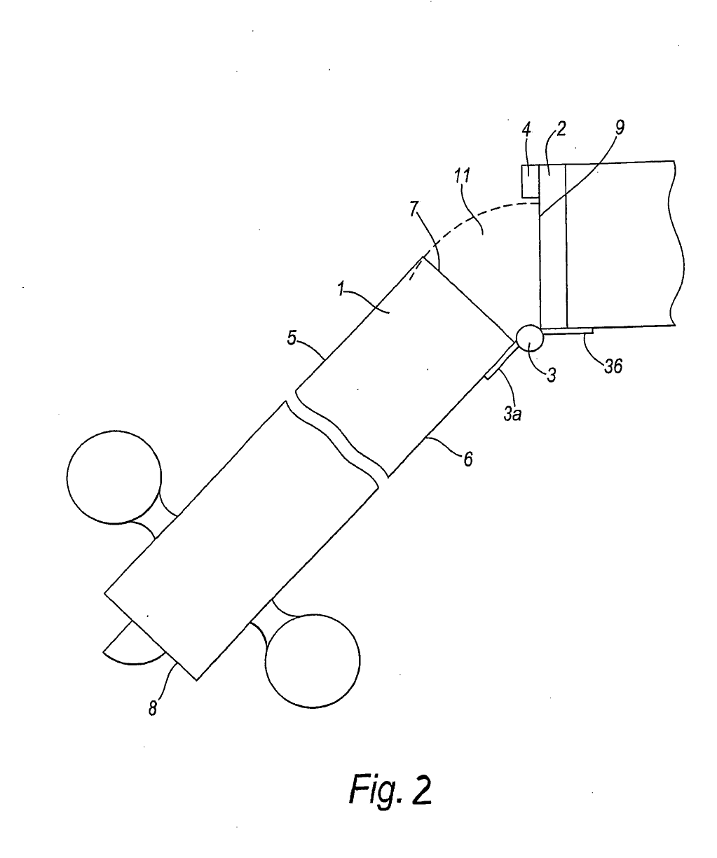

FIG. 2 shows a cross section from above of a door and associated doorframe;

FIG. 3 shows an perspective view of the door and associated doorframe shown in FIG. 1;

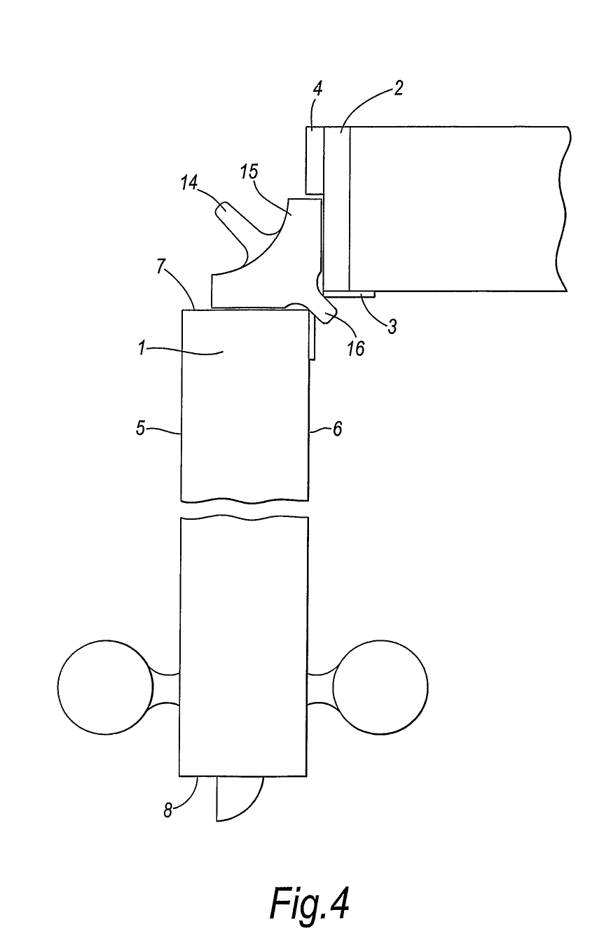

FIG. 4 shows a cross section view from above of a device embodying the present invention the present invention in use.

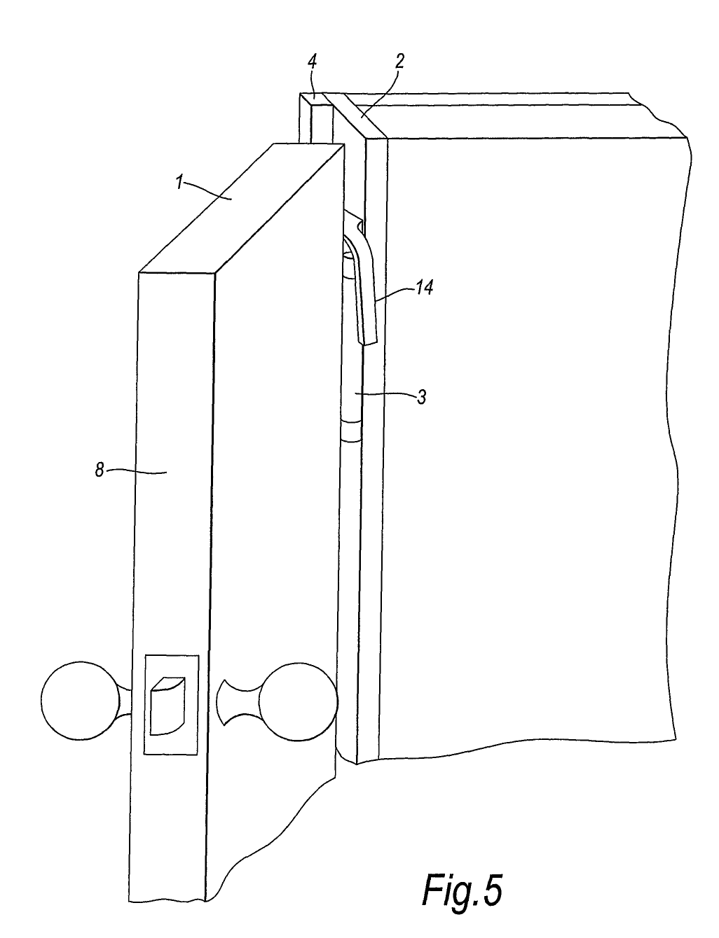

FIG. 5 shows a perspective view of a device embodying the present invention when in use;

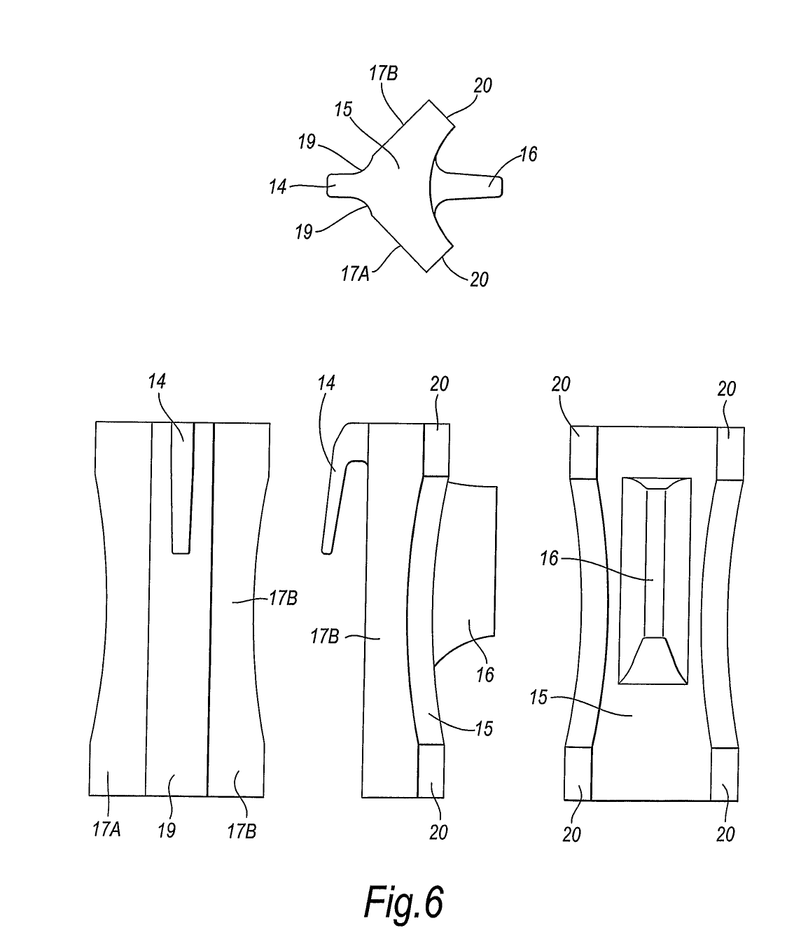

FIG. 6 shows the front, rear and side elevations and plan view of a device embodying the present invention;

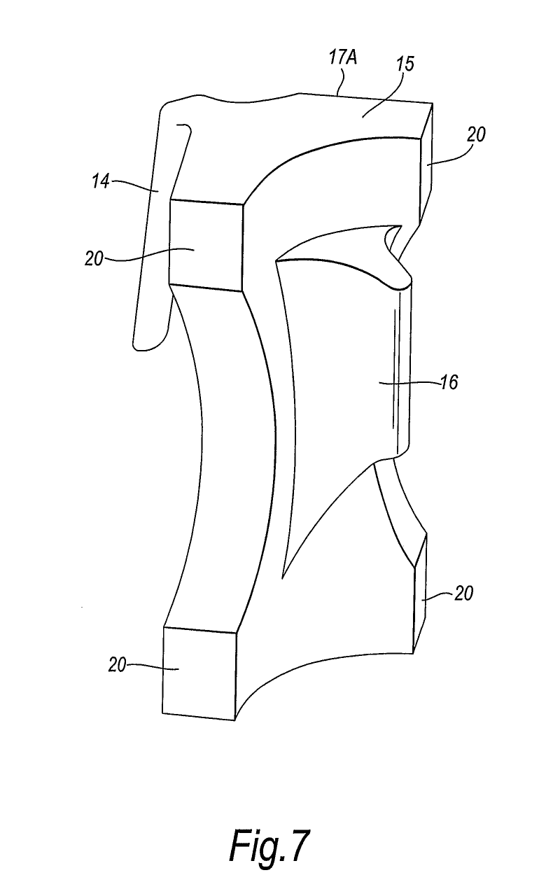

FIG. 7 shows a perspective view of a device embodying the present invention; and

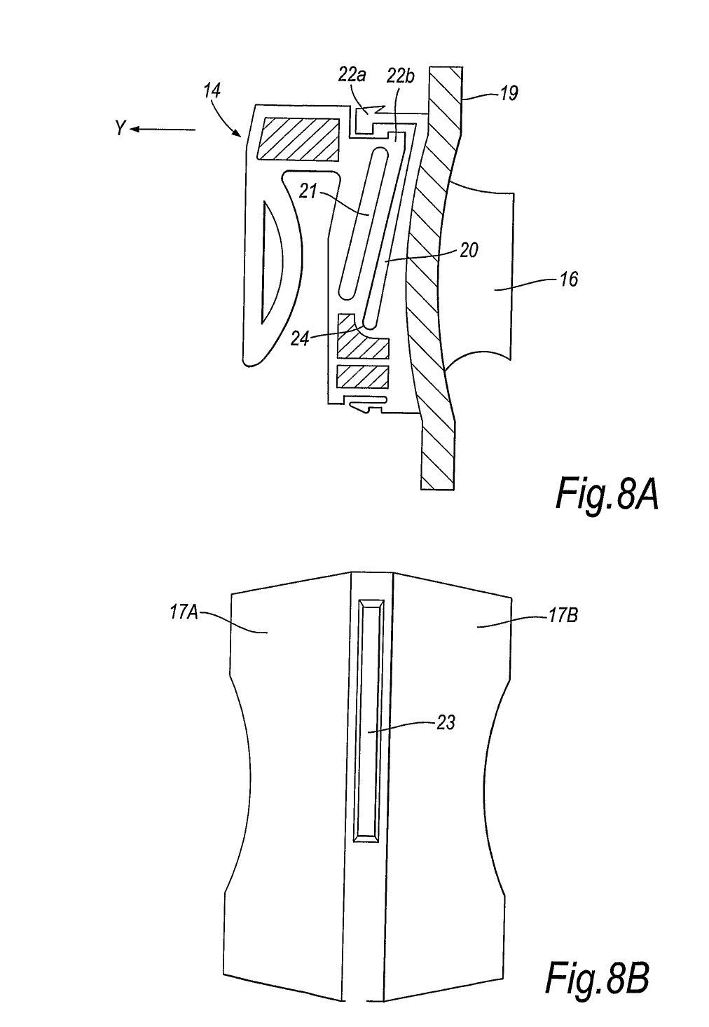

FIG. 8 shows a two-part device embodying the present invention.

The following reference numerals are employed throughout the accompanying drawings to denote parts having the same or similar function:
1. Door;
2. Doorframe;
3. Hinge;
4. Abutment portion;
5. Front face of door;
6. Back face of door;
7. Hinge edge of door;
8. Latch side of door;
9. Hinge edge of door frame;
10. Latch edge of door frame;
11. Radial Gap between door and doorframe;
12. Hinge corner of door;
13. Hinge corner of door frame;
14. Holding means in the form of a hook;
15. Body;
16. Handle;
17. Primary working faces;
18. Corner face;
19. Secondary working faces;
20. First opening
21. Second opening
22. Abutment member;
23. Slot; and
24. Pivotal connection

Domestic, commercial and industrial door systems amount to the vast majority of door systems in use although some of their attributes, e.g. size and shape, may vary considerably. Devices according to preferred embodiments of the present invention are shown in FIGS. 5, 6 and 7 however it should be noted that these specific embodiments may have attributes or features applicable to the domestic door system which may or may not be useful, or appropriate, for use with embodiments intended for use in other circumstances.

FIG. 2 shows the operation of a door 1 hingeably mounted to a door frame 2 by means of a hinge 3. In this example, the illustrated components are the same as in FIG. 1 except that the hinge plates 3a and 3b are shown as being mounted to the back face 6 of the door, and the side of the frame 2 which is an extension of the wall. However, for reasons of convention, sides 7 and 9 are typically still referred to as the hinge sides of the door and door frame respectively.

A perspective view of a device embodying the present invention is shown in FIG. 7 and comprises a substantially rigid, generally wedge-shaped body 15 having an integrally formed engagement member in the form of a hook 14. The device is also provided with a handle or grip 16, which may be integrally formed with the compression resistive body by means of injection moulding for example, to facilitate ease of handling and positioning of the device. The handle is suitable for left-handed and right-handed hinged doors.

A cross-sectional view and a number of side views of the device shown in FIG. 7 are shown in FIG. 6. It can be seen that the device is substantially triangular in cross section. The two sides which make contact with the hinge edge of the door and the doorframe in use form two ‘primary working faces’ 17a and 17b. In this embodiment, the primary working faces are connected by a corner race 18. Thus it can be seen that the corner where the working faces would otherwise meet has been filleted back to accommodate a door hinge 3 as it sits proud of the hinge within the corner created by the door and doorframe upon opening (FIG. 5). The filleting of the corner thus creates the corner face 18. The hook 14, if fitted, is advantageously fitted/formed as part of this corner face.

If an attempt is made to close a door system without a device embodying the present invention located in the radial gap 11, there is nothing in the design of a standard domestic door system to prevent the door from coming together with the doorframe 2 to create what is known as a ‘closed door’. In this state some or all of the doors front face 5 or back face 6, including the edges 7 and 9 will come into contact with the doorframe 2 and the abutment portion.

Whereas, if an attempt is made to close a door system with a device embodying the present invention located in the radial gap 11 as shown in FIG. 4, and regardless of the force used, the device will impede/resist the door movement in a closing direction thereby preventing it from closing beyond the angle dictated by the body of the device itself. As such, in accordance with a preferred embodiment of the invention, the angle subtended by the radial gap 11 will not be less than 90 degrees. Thus, anything or anyone in the vicinity of the door frame which would otherwise constitute an obstruction to the door's movement, does not come at risk of damage or injury even at the hinge side of the door.

With reference to FIGS. 4 and 5, it can be seen that as an attempt is made to close the door, the door 1 and the doorframe 2 both confront and come into contact with the primary working faces 17A and 17B of the device (in some cases these will already be in contact) and exert equal but opposing pressure against the device. Thus the device reacts against these pressures and prevents the door system from closing any further than the devices size when fully compressed between the radial gap 11.

The illustrated preferred embodiment of the present invention also has further working faces called ‘secondary working faces’ 19, which are designed to make contact with an abutment portion 4 provided on the door frame. These races may or may not come into effect depending on whether or not a particular door frame is fitted with an abutment portion, the size of the door and doorframe relative to the width of a device embodying the present invention and if the door is left-handed or right-handed. Where one or more of the secondary working faces does confront or come into contact with an abutment portion of a door Frame, the effect is to increase the surface area or contact between the device and the doorframe and thereby to strengthen the stopping effect of the device in use.

FIG. 8 illustrates a particularly preferred embodiment of the present invention comprising a two-part device which, when assembled, comprises a substantially rigid wedge-shaded body. The device is provided with an engagement member in the form of a hook 14.

FIG. 8A shows a second portion of the device comprising secondary working forces 20 and illustrates a preferred shock absorbing means in the form of a pivotal connection between the engagement member 14 and an internal surface of the second portion. The pivotal connection 24 is achieved by means of an opening 20 which serves to separate a partial length of the hook from the internal surface of the device, thereby allowing a degree of movement to occur with relatively little force between the internal surface and the hook as indicated by arrow Y. In this particular illustration, a second opening 21 is also provided which serves to reduce the rigidity of the hook allowing for a greater degree of flex. The device is provided with a pair of abutment members 22a and 22b which serve to limit the relative movement between the body of the device and the hook.

FIG. 5B shows a first portion of the device having two primary working faces 17A and 17B and being substantially wedge shaped. In order to assemble the device for use, hook 14 is inserted into the slot 23 of the first portion and the two portions are pushed together and held in place by means of a plurality of snap-fit connections.

The parts of this embodiment are formed of injection molded plastic.

Although the present invention is applicable to all closure members employed in any opening or closing access or exit systems, most of the description makes reference an anti-movement device which is intended to be used in conjunction with a door. It should be understood however that the embodiments of the present invention are generally applicable to any number of systems where a closure member is hingeably mounted to a frame portion which defines one side of an opening between two areas of space. The design, shape size construction or a device embodying the present invention can be modified to sit a particular situation.

1. A device for inhibiting the movement of a closure member which is hingeably mounted to a frame portion defining an edge of an opening between two areas of space, wherein the closure member is operable to move about the frame portion in a closing direction so as to reduce the size of the opening, and an opening direction so as to increase the size of the opening, wherein the anti-movement device comprises:
i) a compression resistive body;
ii) a holding means for holding the compression resistive body in a radial gap formed between the closure member and the frame portion as the closure member is moved from the closed position in the opening direction; and
iii) a shock absorbing means which allows for relative movement between the compression resistive body and the holding means, wherein, when positioned in the radial gap in use, the compression resistive body serves to resist movement of the closure member in the closing direction.

2. A device as claimed in claim 1, wherein the holding means comprises an engagement member for cooperating with the, or one of the, hinges.

3. A device as claimed in claim 2, wherein the engagement member comprises a hook.

4. A device as claimed in claim 2 or 3, wherein the shock absorbing means comprises a pivotal connection between the compression resistive body and the engagement member.

5. A device as claimed in any preceding claim, further comprising limiting means operable to limit the relative movement between the compression resistive body and the holding means.

6. A device as claimed in claim 5, when appended to claim 4, wherein said limiting means comprises an abutment member provided on the engagement member which is operable to contact a corresponding abutment member provided on the compression resistive body.

7. A device as claimed in any preceding claim, wherein the holding means comprises a fastening means for allowing the device to be attached, within the radial gap, to the surface of the closure member and/or the frame portion to which the closure member is hingeably mounted.

8. A device as claimed in any preceding claim, wherein the compression resistive body is generally wedge shaped.

9. A device as claimed in any preceding claim, wherein the cross section of the compression resistive body is generally in the form of a triangle.

10. A device as claimed in any preceding claim, wherein the cross section of the compression resistive body is generally in the form of an isosceles triangle.

11. A device as claimed in any one preceding claim, wherein the cross section of the compression resistive body is generally in the form of a right angled triangle.

12. A device as claimed in any preceding claim, wherein the compression resistive body is shaped so as to resist movement of the closure member in a closing direction which would reduce the angle subtended by the radial gap to less than substantially 90 degrees.

13. A device as claimed in any preceding claim, wherein the compression resistive body is shaped so as to resist any movement of the closure member in a closing direction which would reduce the angle subtended by the radial gap to less than substantially 60 degrees.

14. A device as claimed in any preceding claim, wherein the compression resistive body is shaped so as to resist any movement of the closure member in a closing direction which would reduce the angle subtended by the radial gap to less than substantially 30 degrees.

15. A device as claimed in any preceding claim, wherein the compression resistive body comprises two or more primary working faces which, when the device is positioned in the radial gap, abut the closure member and the frame portion.

16. A device as claimed in any preceding claim, further comprising a handle.

17. A device as claimed in any preceding claim, wherein the compression resistive body is in the form of a rigid core which is covered, coated or surrounded by a material which has some degree of compressibility.

18. A device as claimed in any one of claims 1 to 16, wherein the device is formed of injection moulded plastic.

19. A device as claimed in any preceding claim, wherein the compression resistive body comprises first and second portions which may be connected together for use.

20. A device as claimed in claim 19, wherein the first portion of the compression resistive body is generally wedge-shaped and comprises two primary working faces, and wherein the second portion comprises two secondary working faces.

21. A device as claimed in claim 20, when appended to claim 4, wherein the pivotal connection is between the engagement member and an internal surface of the second portion of the compression resistive body.

22. A device as claimed in any preceding claim, wherein the device is an anti-movement device.

23. Use of a device as claimed in any preceding claim.

24. A method of inhibiting the movement of a closure member which is hingeably mounted by means of one or more hinges to a frame portion defining an edge of an opening between two areas of space, wherein the closure member is operable to move about the frame portion in a closing direction so as to reduce the size of the opening, and an opening direction so as to increase the size of the opening, wherein the method comprises:
i) positioning a device having a compression resistive body in a radial gap formed between the closure member and the frame portion as the closure member is moved from the closed position in the opening direction, the compression resistive body being held in the radial gap by means of a holding means and wherein the device is provided with a shock absorbing means which allows for relative movement between the compression resistive body and holding means.
